(19) United States
(12) Patent Application Publication
(10) Pub. No.: US 2017/0012798 A1
(43) Pub. Date: Jan. 12, 2017

(54) TRANSMISSION APPARATUS, TRANSMISSION METHOD, RECEPTION APPARATUS, AND RECEPTION METHOD

(71) Applicant: SONY CORPORATION, TOKYO (JP)

(72) Inventor: SATOSHI TERAMOTO, SAITAMA (JP)

(21) Appl. No.: 15/121,162

(22) PCT Filed: Feb. 16, 2015
(86) PCT No.: PCT/JP2015/054086

§ 371 Date: Aug. 24, 2016

(30) Foreign Application Priority Data
Mar. 3, 2014 (JP) 2014-041034

(51) Int. Cl. H04L 12/403; H04B 3/50; H04L 29/06

(52) U.S. Cl. CPC H04L 12/4035; H04L 65/601; H04B 3/50

(57) ABSTRACT

To allow good transmission and reception of a plurality of streams of data corresponding to respective ones of a plurality of data channels. A transmitting side transmits a plurality of streams of data corresponding to respective ones of a plurality of data channels, through a transmission path. At this time, the transmitting side inserts, into each of the plurality of streams of data, identification information for identifying the corresponding data channel. A receiving side determines to which of the data channels each of the plurality of streams of data corresponds, on the basis of the inserted identification information. Thereafter, on the basis of the determination result, the receiving side processes the plurality of streams of data.

### TECHNICAL FIELD

The present technology relates to transmission apparatuses, transmission methods, reception apparatuses, and reception methods. In particular, the present technology relates to, for example, a transmission apparatus for transmitting a plurality of streams of data corresponding to respective ones of a plurality of data channels.

### BACKGROUND ART

The Mobile High-definition Link (MHL) standard has conventionally been proposed for a communication interface that allows high-speed transmission of image and audio data from a transmitter (source apparatus) to a receiver (sink apparatus). In conventional MHL systems, for example, content data is transmitted from a transmitter to a receiver through a single data channel.

In conventional digital High-Definition Multimedia Interface (HDMI) interfaces, content data is divided into a plurality of streams of data, which are transmitted from a transmitter to a receiver through a plurality of data channels. In this case, in order to allow the receiver to perform an appropriate process, it is necessary to correctly input the plurality of streams of data into the respective corresponding pins of the receptacle of the receiver.

For example, Patent Literature 1 indicates that, by inserting a connector identifier into each signal pin of the connector of the signal transmitter circuit, the internal circuit is prevented from being broken due to incorrect connection of the connector.

### CITATION LIST

### Patent Literature

Patent Literature 1: JP H6-068935A

### SUMMARY OF INVENTION

### Technical Problem

It is an object of the present technology to allow good transmission and reception of a plurality of streams of data corresponding to respective ones of a plurality of data channels.

### Solution to Problem

According to an aspect of the present technology, a transmission apparatus includes:

a transmission unit configured to transmit a plurality of streams of data corresponding to respective ones of a plurality of data channels, to an external apparatus through a transmission path; and

an information addition unit configured to add, to each of the plurality of streams of data, identification information for identifying the corresponding data channel.

In the present technology, the transmission unit transmits a plurality of streams of data corresponding to respective ones of a plurality of data channels, to an external apparatus through a transmission path. The information insertion unit inserts, to each of the plurality of streams of data, identification information for identifying the corresponding data channel.

For example, the data channel may be a TMDS data channel. The information addition unit may add, to a control period of each piece of TMDS line data, the identification information for identifying the corresponding data channel. Also, for example, information about the total number of the data channels may be added to the identification information for identifying the corresponding data channel.

Thus, in the present technology, to each of a plurality of streams of data, identification information for identifying the corresponding data channel is added. Therefore, a receiving side can easily and correctly determine to which of the data channels each of the received plurality of streams of data corresponds, and perform an appropriate process on the received plurality of streams of data.

Note that, in the present technology, for example, the transmission apparatus may further include a data processing unit configured to obtain the plurality of streams of data from one or more pieces of content data. Also, in the present technology, the transmission apparatus may further include a receptacle having a plurality of pins for outputting respective ones of the plurality of streams of data. The receptacle may be reversibly connectable to a plug of a cable forming the transmission path. In this case, even when the plug of the cable is in any connection direction, a receiving side can easily and correctly determine to which of the data channels each of the received plurality of streams of data corresponds, and perform an appropriate process on the received plurality of streams of data.

Also, according to another aspect of the present technology, a reception apparatus includes:

a reception unit configured to receive a plurality of streams of data, to each of which identification information for identifying a corresponding data channel is added, from an external apparatus through a transmission path; and

a determination unit configured to determine to which of the data channels each of the plurality of streams of data corresponds, on the basis of the inserted identification information.

In the present technology, the reception unit receives a plurality of streams of data from an external apparatus through a transmission path. Here, to each of the plurality of streams of data, identification information for identifying a corresponding data channel is inserted. For example, the data channel is a TMDS data channel. The identification information is added to a control period of TMDS line data. The determination unit determines to which of the data channels each of the plurality of streams of data corresponds, on the basis of the inserted identification information.

Thus, in the present technology, it is determined to which of data channels each of a plurality of streams of data corresponds, on the basis of identification information inserted therein. Therefore, it can be easily and correctly determined to which of the data channels each of the plurality of streams of data corresponds, and an appropriate process can be performed on the plurality of streams of data.

Note that, in the present technology, for example, the reception apparatus may further include a data processing unit configured to combine the plurality of streams of data together, on the basis of a result of the determination, to obtain one or more pieces of content data. Also, in the present technology, the reception apparatus may further include a receptacle having a plurality of pins for receiving respective ones of the plurality of streams of data. The receptacle may be reversibly connectable to a plug of a cable forming the transmission path. In this case, even when the plug of the cable is in any connection direction, a receiving side can easily and correctly determine to which of the data channels each of the received plurality of streams of data corresponds, and perform an appropriate process on the received plurality of streams of data.

### Advantageous Effects of Invention

According to the present technology, allowed is good transmission and reception of a plurality of streams of data corresponding to respective ones of a plurality of data channels. Note that the advantageous effects described herein are merely illustrative and not restrictive, and there may be additional advantageous effects.

### BRIEF DESCRIPTION OF DRAWINGS

FIG. 1 is a block diagram showing a configuration example of an image display system according to an embodiment.

FIG. 2 is a block diagram showing a configuration example of a mobile phone included in an image display system.

FIG. 3 is a block diagram showing a configuration example of a television set included in an image display system.

FIG. 4 is a diagram showing a configuration example of an MHL transmission unit in a mobile phone and an MHL reception unit in a television set.

FIG. 5 is a block diagram showing a detailed configuration example of a transmitter which is an MHL transmission unit.

FIG. 6 is a conceptual diagram showing the structure of MHL data.

FIG. 7 is a conceptual diagram of the structure of TMDS line data.

FIG. 8 is a block diagram showing a detailed configuration example of a receiver which is an MHL reception unit.

FIG. 9 is a flowchart schematically showing transmission and reception processes of MHL data performed by an MHL transmission unit and an MHL reception unit.

FIG. 10 is a diagram for describing an application of the present technology to a reversible connector.

FIG. 11 is a diagram showing an example of a base board shape and a connector arrangement in an MHL sink apparatus.

FIG. 12 is a diagram showing examples of MHL devices (MHL reception units) (A), (B), and (C) provided in an MHL sink apparatus.

FIG. 13 is a diagram showing a wiring pattern example in which an MHL device (A) is provided in an MHL sink apparatus.

FIG. 14 is a diagram showing a wiring pattern example in which an MHL device (B) is provided in an MHL sink apparatus.

FIG. 15 is a diagram showing a wiring pattern example in which an MHL device (B) is provided in an MHL sink apparatus, and the present technology is applied.

FIG. 16 is a diagram showing a wiring pattern example in which an MHL device (C) is provided in an MHL sink apparatus.

FIG. 17 is a diagram showing a wiring pattern example in which an MHL device (C) is provided in an MHL sink apparatus, and the present technology is applied.

### DESCRIPTION OF EMBODIMENT(S)

Modes for carrying out the present invention (hereinafter referred to as “embodiments”) will now be described. Note that description will be provided in the following order.

1. Embodiments

2. Variations

### <1. Embodiments>

### [Image Display System]

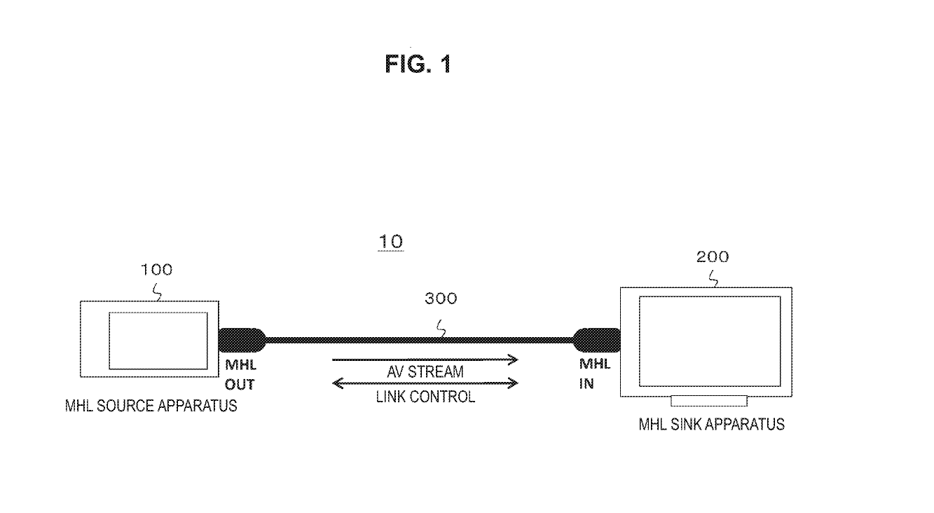

FIG. 1 shows a configuration example of an image display system 10 according to an embodiment. The image display system 10 includes a mobile phone 100 as a Mobile High-definition Link (MHL) source apparatus, and a television set 200 as an MHL sink apparatus. These apparatuses are connected together by an MHL cable 300 as a transmission channel.

An overview of MHL will be described. MHL is an audio visual (AV) digital interface standard for, mainly, mobile apparatuses. According to MHL, an MHL source apparatus and an MHL sink apparatus are connected together by an MHL cable, and contents, such as moving images, still images, sounds, and the like, possessed by the MHL source apparatus are played back by the MHL sink apparatus (AV stream/unidirectional).

Also, controls such as reading of EDID, HDCP authentication, reading/writing of a register, control of a remote controller, and the like are performed by transmission and reception of a DDC command and an MHL sideband channel (MSC) command between the apparatuses (link control/bidirectional). The mobile phone 100 and the television set 200 adjust settings for a link between these apparatuses, and exchange content data through the MHL cable 300 according to the values of the link settings.

The mobile phone 100 divides video and audio data, etc., i.e., content data, into a plurality of streams of data, and transmits the plurality of streams of data through a plurality of TMDS data channels. At this time, the mobile phone 100 adds, to each of the plurality of streams of data, identification information (e.g., a number, etc.) for identifying the corresponding TMDS data channel. In this embodiment, the mobile phone 100 inserts the above identification information into a control period of each piece of TMDS line data.

The television set 200 receives a plurality of streams of data. The television set 200 determines to which of the TMDS data channel each stream of data corresponds, on the basis of the identification information added to that stream of data. Thereafter, on the basis of the determination result, the television set 200 combines the plurality of streams of data to obtain content data, such as video, audio, and the like.

### [Configurations of Mobile Phone and Television Set]

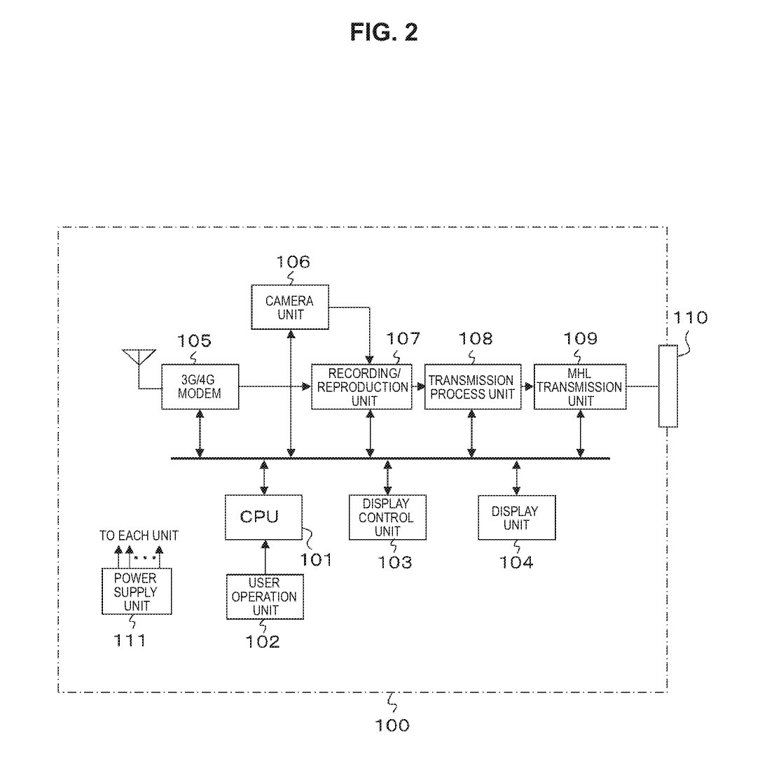

FIG. 2 shows a configuration example of the mobile phone 100. The mobile phone 100 includes a CPU 101 as a control unit, a user operation unit 102, a display control unit 103, a display unit 104, a 3G/4G modem unit 105, a camera unit 106, a recording/reproduction unit 107, a transmission process unit 108, an MHL transmission unit 109, an MHL terminal (receptacle) 110, and a power supply unit 111.

The CPU 101 controls an operation of each unit of the mobile phone 100. The user operation unit 102 and the display unit 104 form a user interface. The user operation unit 102 is connected to the CPU 101. The user operation unit 102 includes a key, button, dial, or switch which is provided on a housing (not shown) of the mobile phone 100, or a touch panel provided on a display surface of the display unit 104, or a mouse or keyboard, or a gesture input unit which performs detection using a camera, or a voice input unit which performs detection using a microphone, or a remotely controlled transmitter/receiver, or the like.

The display control unit 103 controls the display of the display unit 104. The display unit 104 includes, for example, a liquid crystal display (LCD), an organic electro-luminescence (EL) panel, or the like. Note that, in this embodiment, an example is illustrated in which the display control unit 103 is provided in addition to the CPU 101. Alternatively, the CPU 101 may directly control the display of the display unit 104. The CPU 101 and the display control unit 103 may be implemented as a single chip or a plurality of cores. The power supply unit 111 supplies power to each unit of the mobile phone 100. The power supply unit 111 may be an AC power supply or a battery (a rechargeable battery or a dry cell battery).

The 3G/4G modem 105 performs mobile telephone communication. The camera unit 106 captures a moving image and a still image. The recording/reproduction unit 107 drives an internal memory (non-volatile memory), or a recording medium such as a memory card or the like, for recording or retrieval (writing or reading). The recording/reproduction unit 107 performs recording/reproduction of a call through the modem 105.

The recording/reproduction unit 107 also performs recording/reproduction of image data (a moving image, a still image) and audio data acquired through the modem 105, recording/reproduction of image data (a moving image, a still image) and audio data captured and obtained by a camera unit (including a microphone) 106, or the like. Note that the recording/reproduction unit 107 also performs a codec process for data compression on image data (a moving image, a still image) captured and obtained by the camera unit 106.

The user can instruct the display unit 104, using the user operation unit 102, to display a list of contents recorded in a recording medium included in the recording/reproduction unit 107. When the user chooses any one from the content list using the user operation unit 102, the data of the chosen content is reproduced from the recording medium by the recording/reproduction unit 107, and transferred to the transmission process unit 108.

Note that the video data and audio data acquired by the 3G/4G modem 105 or the video data and audio data acquired by the camera unit 106 may be transmitted in real time. In this case, the content data is directly transferred to the transmission process unit 108, although not shown. Alternatively, a memory card may be inserted into another device, which then writes content data into the memory card, and thereafter inserted into the recording/reproduction unit 107 so that the content data is transferred to the transmission process unit 108.

The transmission process unit 108 processes and adjusts the resolution, frame rate, color depth, color space, and the like of image data which has been supplied from the recording/reproduction unit 107 and is to be transferred to the television set 200, to the values of the link settings in the MHL transmission unit 109. The MHL transmission unit 109 is connected to the MHL terminal 110.

The MHL transmission unit 109 unidirectionally transmits content data, such as video, audio, and the like, processed by the transmission process unit 108, from the MHL terminal 110 to the television set 200 through the MHL cable 300, by communication compliant with the MHL standard. In this embodiment, the MHL transmission unit 109 divides the MHL data into a plurality of pieces of TMDS line data, and transmits the plurality of pieces of TMDS line data through a plurality of TMDS channels. At this time, the MHL transmission unit 109 adds, to the control period of each piece of TMDS line data, identification information for identifying the corresponding TMDS data channel. The MHL transmission unit 109 will be described in detail below.

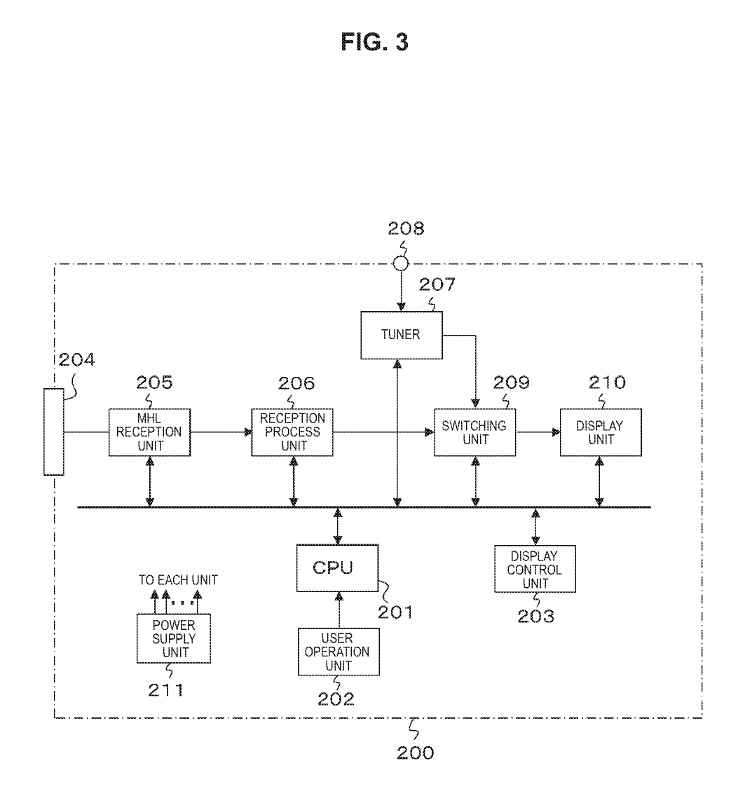

FIG. 3 shows a configuration example of the television set 200. The television set 200 has a CPU 201 as a control unit, a user operation unit 202, a display control unit 203, an MHL terminal (receptacle) 204, an MHL reception unit 205, a reception process unit 206, a tuner 207, an antenna terminal 208, a switching unit 209, a display unit 210, and a power supply unit 211.

The control unit 201 controls an operation of each unit of the television set 200. The user operation unit 202 forms a user interface, and is connected to the control unit 201. The user operation unit 202 includes a key, button, dial, or switch which is provided on a housing (not shown) of the reception apparatus 200, or a touch panel provided on a display surface of the display unit 210, or a mouse or keyboard, or a gesture input unit which performs detection using a camera, or a voice input unit which performs detection using a microphone, or a remotely controlled transmitter/receiver, or the like.

The display control unit 203 controls the display of the display unit 210. The display unit 210 includes, for example, a liquid crystal display (LCD), an organic electro-luminescence (EL) panel, or the like. Note that, in this embodiment, an example is illustrated in which the display control unit 203 is provided in addition to the CPU 201. Alternatively, the CPU 201 may directly control the display of the display unit 210. The CPU 201 and the display control unit 203 may be implemented as a single chip or a plurality of cores. The power supply unit 211 supplies power to each unit of the television set 200. The power supply unit 211 may be an AC power supply or a battery (a rechargeable battery or a dry cell battery).

The MHL reception unit 205 is connected to the MHL terminal 204. The MHL reception unit 205 receives content data of video, audio, and the like unidirectionally transmitted from the MHL transmission unit 109 of the mobile phone 100 connected thereto through the MHL cable 300, by communication compliant with the MHL standard. The MHL reception unit 205 sends the received video data to the reception process unit 206. Note that the audio data received by the MHL reception unit 205 is supplied to an audio data reception process unit (not shown).

In this embodiment, the MHL reception unit 205 receives a plurality of pieces of TMDS line data. At this time, the MHL reception unit 205 determines to which of the TMDS data channels each piece of TMDS line data corresponds, on the basis of the identification information inserted in the control period of that TMDS line data. On the basis of the determination result, the MHL reception unit 205 optionally rearranges the pieces of TMDS line data before combining the pieces of TMDS line data to obtain the same MHL data that has been transmitted by the transmitting side. The MHL reception unit 205 will be described in detail below.

The reception process unit 206 performs a necessary process such as a scaling process (resolution conversion process), gamma correction, or the like on the video data acquired by the MHL reception unit 205. The reception process unit 206 supplies the processed image data to the switching unit 209.

The tuner 207 receives a broadcasting-satellite service, a digital terrestrial broadcasting service, or the like. The tuner 207 is supplied with a broadcast signal captured by an antenna (not shown) connected to the antenna terminal 208. The tuner 207 acquires the video data (video signal) and audio data of a predetermined program on the basis of a broadcast signal. The switching unit 209 selectively obtains video data processed by the reception process unit 206 or video data acquired the tuner 207, and supplies the video data to the display unit 210.

Operations of the mobile phone 100 shown in FIG. 2 and the television set 200 shown in FIG. 3 will be briefly described. Content data reproduced from the recording/reproduction unit 207 of the mobile phone 100, or content data acquired by the 3G/4G modem 105, or content data acquired by the camera unit 106, is supplied to the transmission process unit 108.

The transmission process unit 108 processes and adjusts the resolution, frame rate, color depth, color space, and the like of image data to be transmitted to the television set 200, to the values of the link settings in the MHL transmission unit 109. The MHL transmission unit 109 unidirectionally transmits the content data processed by the transmission process unit 108 from the MHL terminal 110 to the television set 200 through the MHL cable 300, by communication compliant with the MHL standard.

The MHL reception unit 205 of the television set 200 receives content data unidirectionally transmitted from the MHL transmission unit 109 of the mobile phone 100 through the MHL cable 300, by communication compliant with the MHL standard. Image data received by the MHL reception unit 205 is transferred to the reception process unit 206, which then performs a scaling process (resolution conversion process), gamma correction, or the like on the image data. The processed video data is supplied to the switching unit 209.

The tuner 207 receives a broadcasting-satellite service, a digital terrestrial broadcasting service, or the like. Video data acquired by the tuner 207 is supplied to the switching unit 209. The switching unit 209 selectively obtains video data processed by the reception process unit 206 or video data acquired the tuner 207, and supplies the video data to the display unit 210.

### [Configurations of MHL Transmission Unit and MHL Reception Unit]

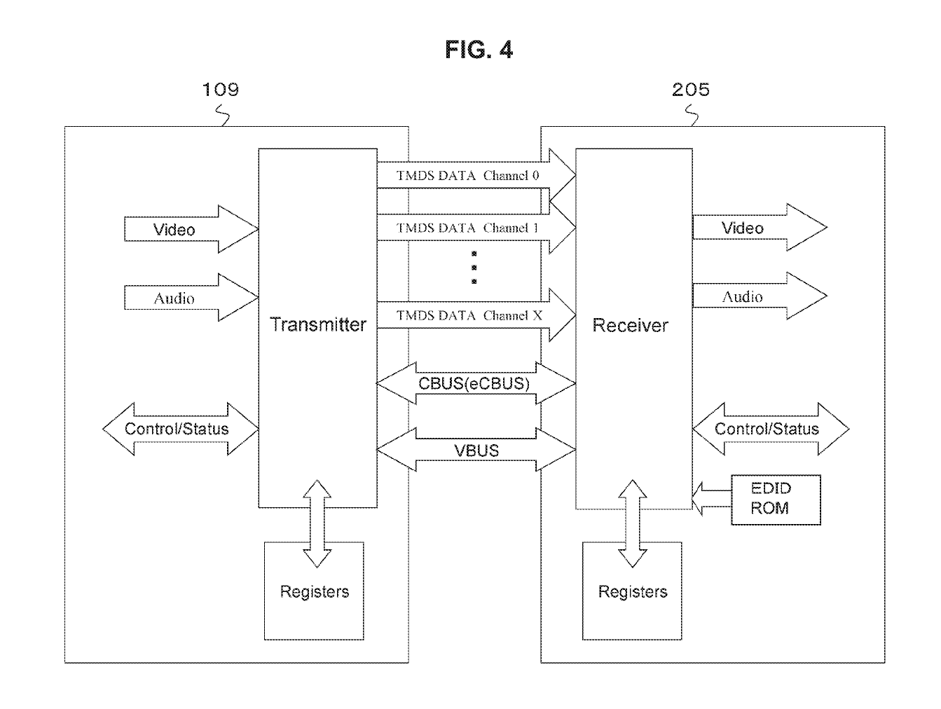

FIG. 4 shows a configuration example of the MHL transmission unit 109 of the mobile phone 100 of FIG. 2, and a configuration example of the MHL reception unit 205 of the television set 200 of FIG. 3. The MHL transmission unit 109 includes a transmitter, and the MHL reception unit 205 includes a receiver. The MHL transmission unit 109 and the MHL reception unit 205 are connected together by (X+1) TMDS data channels (where X is an integer of one or more), CBUS (eCBUS), and VBUS.

Each TMDS data channel, which includes a twisted pair, is used to transmit an AV stream and a synchronization signal (MHL clocks) therefor. CBUS is used to bidirectionally transfer a DDC command and an MSC command. A DDC command is used for reading of EDID or HDCP authentication. An MSC command is used for EDID reading control, reading/writing of various registers, control of a remote controller, and the like. VBUS is used to supply a power of +5 V from the MHL sink apparatus to the MHL source apparatus or from the MHL source apparatus to the MHL sink apparatus.

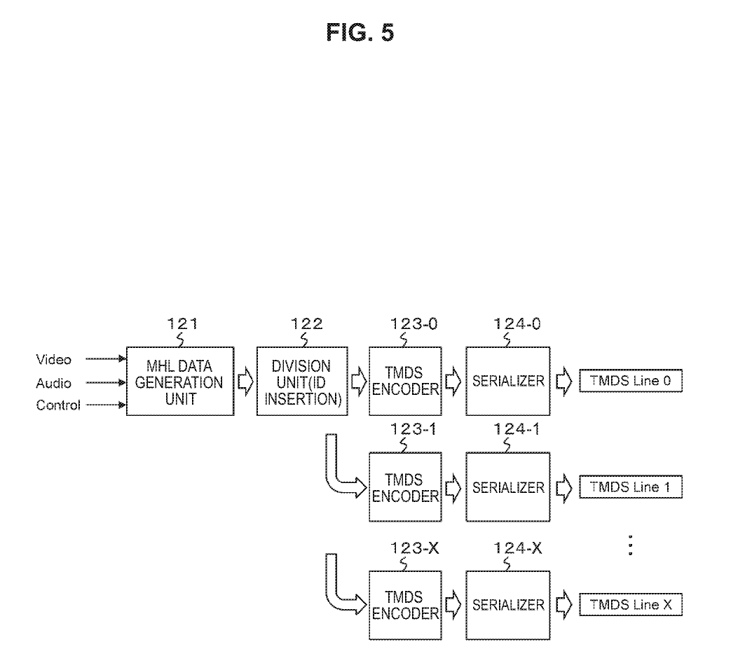

FIG. 5 shows a detailed configuration example of a transmitter which is the MHL transmission unit 109. The transmitter has an MHL data generation unit 121, a division unit 122, TMDS encoders 123-0 to 123-X, and serializers 124-1 to 124-X. The MHL data generation unit 121 generates MHL data from video data, audio data, a control signal, and the like.

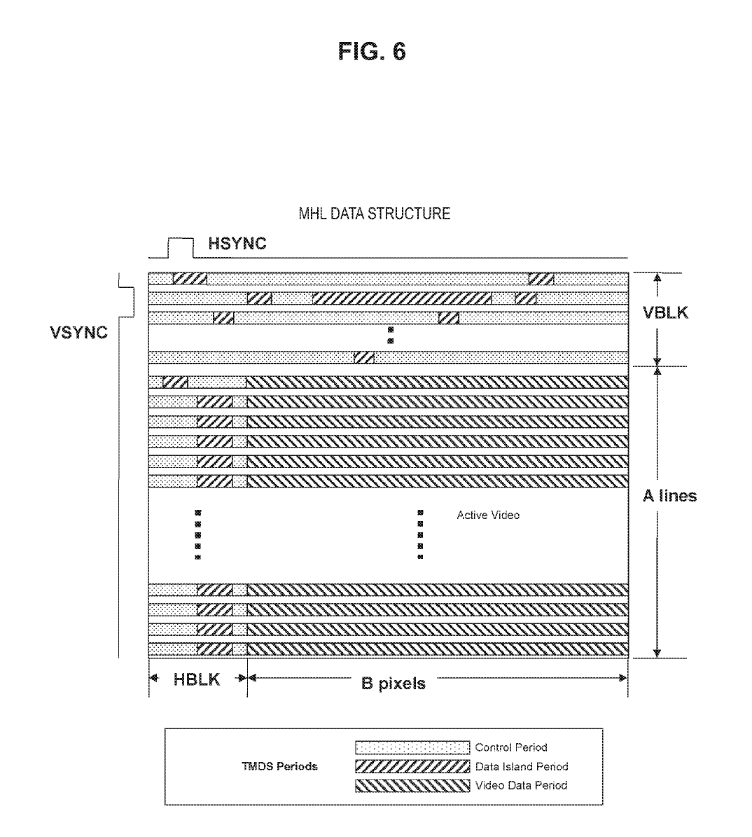

FIG. 6 is a conceptual diagram showing the structure of MHL data. FIG. 6 shows periods for various items of transmission data, where image data of B pixels (width)×A lines (length) is transmitted through TMDS data channels #0 to #X. A video field in which transmission data is transmitted through the TMDS data channels includes three periods corresponding to the items of transmission data. The three periods are a video data period, a data island period, and a control period.

Here, the video field period is a period from an active edge of a vertical synchronization signal to the next active edge of the vertical synchronization signal. The video field period is divided into a horizontal blanking period, a vertical blanking period, and an active video period. The active video period is a period obtained by removing the horizontal blanking period and the vertical blanking period from the video field period. The video data period is assigned to the active video period. During the video data period, the data of active pixels of B pixels x A lines constituting uncompressed image data corresponding to one screen, is transmitted.

The data island period and the control period are assigned to the horizontal blanking period and the vertical blanking period. During the data island period and the control period, auxiliary data is transmitted. In other words, the data island period is assigned to a portion of the horizontal blanking period and the vertical blanking period. During the data island period, of the auxiliary data, data which is not involved in control, such as packets of audio data and the like, is transmitted. The control period is assigned to the other portion of the horizontal blanking period and the vertical blanking period. During the control period, of the auxiliary data, data which is involved in control, such as a vertical synchronization signal, a horizontal synchronization signal, control packets, and the like, is transmitted.

Referring back to FIG. 5, the division unit 122 divides the MHL data generated by the MHL data generation unit 121 to generate TMDS line data 0 to X which are to be transmitted through the TMDS data channels 0 to X. At this time, the division unit 122 inserts, into the control period of each piece of TMDS line data, identification information for identifying the corresponding TMDS data channel, such as channel number data.

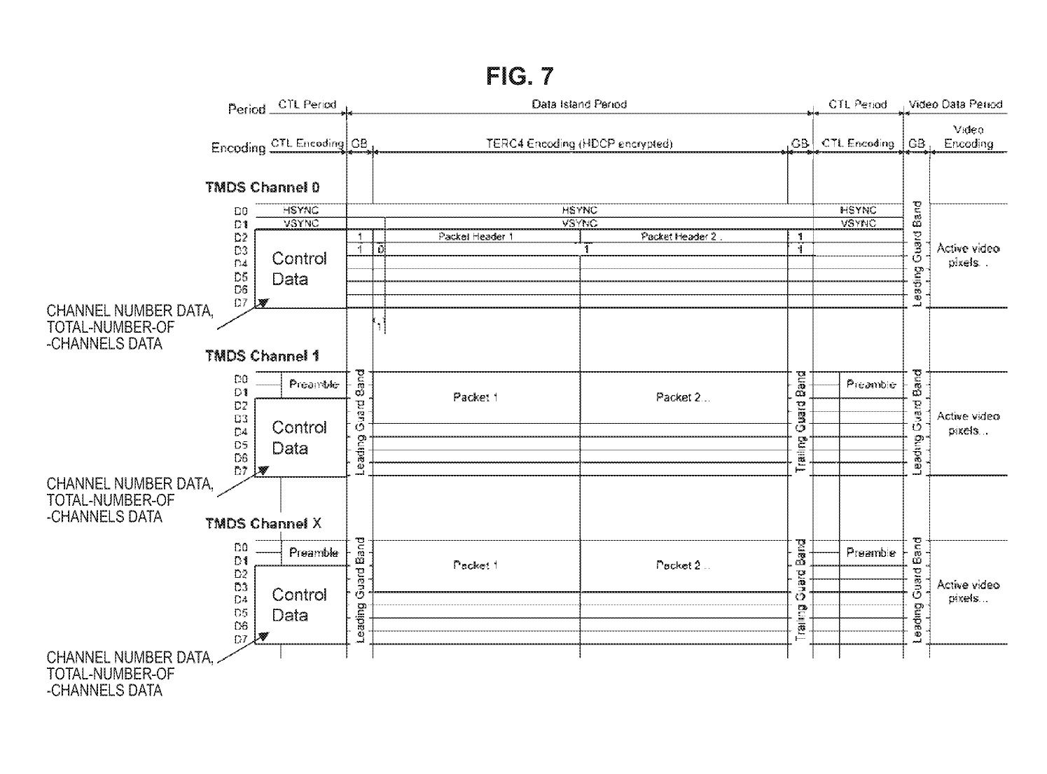

FIG. 7 is a conceptual diagram of the structure of each piece of TMDS line data. As shown in FIG. 7, in the control period, channel number data and total-number-of-channels data are inserted as control data.

The TMDS encoders 123-0 to 123-X convert the TMDS line data 0 to X, respectively, into TMDS signals. The serializers 124-0 to 124-X serialize the TMDS signals 0 to X to obtain TMDS line data 0 to X, respectively, as transmission signals.

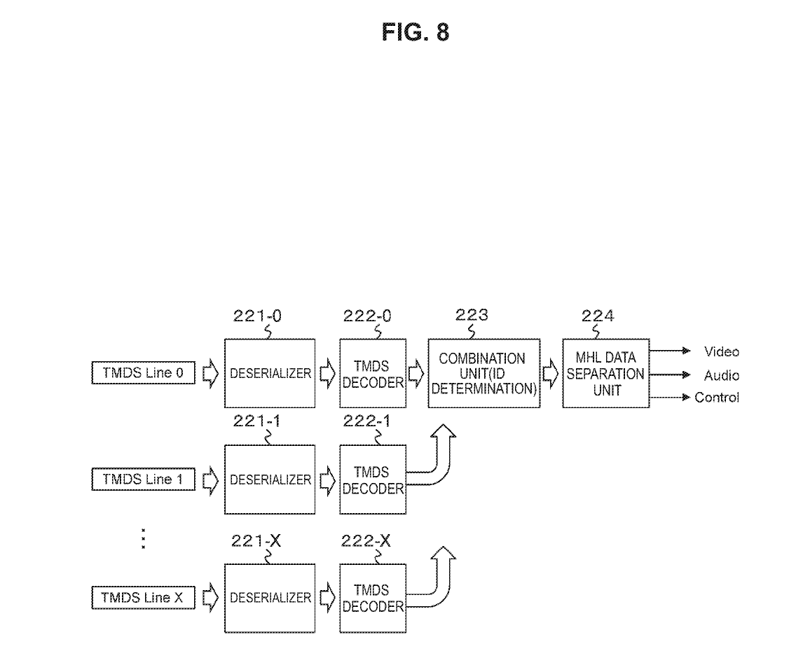

FIG. 8 shows a detailed configuration example of a receiver which is the MHL reception unit 205. The receiver has deserializers 221-0 to 221-X, TMDS decoders 222-0 to 222-X, a combination unit 223, and an MHL data separation unit 224. The deserializers 221-0 to 221-X each deserialize and convert an (X+1)th stream of TMDS line data as a received signal into an (X+1)th stream of TMDS signal.

The TMDS decoders 222-0 to 222-X each convert an (X+1)th stream of TMDS signal into TMDS line data. The combination unit 223 determines to which of the TMDS data channels each (X+1)th stream of TMDS line data corresponds, on the basis of the channel number data inserted in the control period. Thereafter, on the basis of the determination signal, the combination unit 223 optionally rearranges the TMDS line data 0 to X before combining the TMDS line data 0 to X together to obtain MHL data. The MHL data separation unit 224 separates the MHL data into video data, audio data, a control signal, and the like.

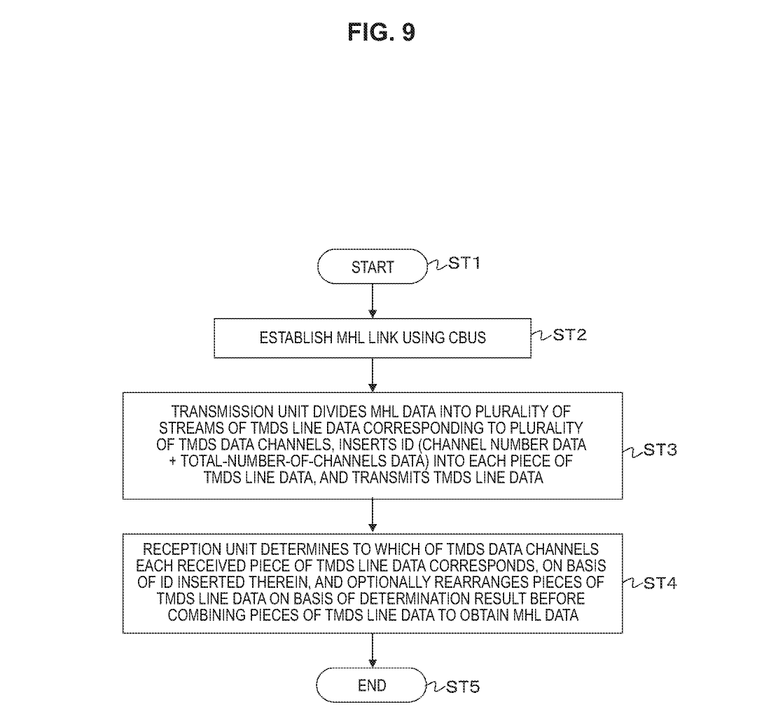

A flowchart of FIG. 9 schematically shows transmission and reception processes of MHL data performed by the MHL transmission unit 109 and the MHL reception unit 205. In step ST1, the process starts. Thereafter, in step ST2, the MHL transmission unit 109 and the MHL reception unit 205 perform communication through CBUS to establish an MHL link.

Next, in step ST3, the MHL transmission unit 109 divides the MHL data into a plurality of streams of TMDS line data corresponding to a plurality of TMDS data channels, inserts an ID (channel number data+total-number-of-channels data) into each stream of TMDS line data, and transmits the plurality of streams of TMDS line data.

Next, in step ST4, on the basis of the ID inserted in each received stream of TMDS line data, the MHL reception unit 205 determines to which of the TMDS data channels that received stream of TMDS line data corresponds. On the basis of the determination result, the MHL reception unit 205 optionally rearranges the streams of TMDS line data before combining the streams of TMDS line data to obtain MHL data. After the process of step ST4, the process ends in step ST5.

As described above, in the image display system 10 of FIG. 1, the MHL transmission unit 109 of the mobile phone 100 divides MHL data into a plurality of pieces of TMDS line data. When transmitting the plurality of pieces of TMDS line data through a plurality of TMDS channels, the MHL transmission unit 109 adds, to the control period of each piece of TMDS line data, identification information for identifying the corresponding TMDS data channel. Meanwhile, the MHL reception unit 205 of the television set 200 determines to which of the TMDS data channels each stream of contained data corresponds, on the basis of identification information inserted in the control period of that stream of TMDS line data. On the basis of the determination result, the MHL reception unit 205 of the television set 200 optionally rearranges the pieces of TMDS line data before combining the pieces of TMDS line data together to obtain MHL data.

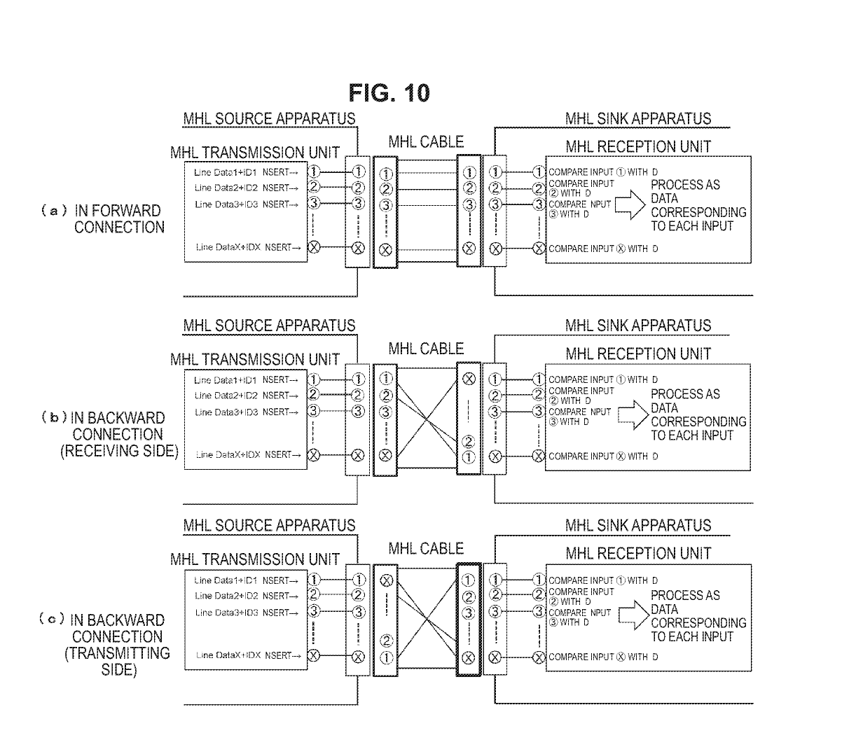

Therefore, the image display system 10 of FIG. 1 can support a reversible connector. For example, as shown in FIG. 10(a), in forward connection, TMDS line data (1) corresponding to the TMDS channel 1, which is output from an output (1) of the MHL transmission unit, is passed through a pin (1) of a receptacle and a pin (1) of a plug of an MHL cable in the MHL source apparatus, and then through a pin (1) of a plug of the MHL cable and a pin (1) of a receptacle in the MHL sink apparatus, and then input to an input (1) of the MHL reception unit. The MHL reception unit determines that the TMDS line data (1) corresponds to the TMDS channel 1, on the basis of the inserted ID, and processes the TMDS line data (1) as TMDS line data corresponding to the TMDS channel 1.

Also, for example, as shown in FIG. 10(b), in backward connection with respect to a receiving side, TMDS line data (1) corresponding to the TMDS channel 1, which is output from an output (1) of the MHL transmission unit, is passed through a pin (1) of a receptacle and a pin (1) of a plug of an MHL cable in the MHL source apparatus, and then through a pin (1) of a plug of the MHL cable and a pin (X) of a receptacle in the MHL sink apparatus, and then input to an input (X) of the MHL reception unit. In this case, it is assumed that the receptacle can be reversibly connected with the plug of the cable. The MHL reception unit determines that the TMDS line data (1) corresponds to the TMDS channel 1, on the basis of the inserted ID, and processes the TMDS line data (1) as TMDS line data corresponding to the TMDS channel 1.

Also, for example, as shown in FIG. 10(c), in backward connection with respect to a transmitting side, TMDS line data (1) corresponding to the TMDS channel 1, which is output from an output (1) of the MHL transmission unit, is passed through a pin (1) of a receptacle and a pin (X) of a plug of an MHL cable in the MHL source apparatus, and then through a pin (X) of a plug of the MHL cable and a pin (X) of a receptacle in the MHL sink apparatus, and then input to an input (X) of the MHL reception unit. In this case, it is assumed that the receptacle can be reversibly connected with the plug of the cable. The MHL reception unit determines that the TMDS line data (1) corresponds to the TMDS channel 1, on the basis of the inserted ID, and processes the TMDS line data (1) as TMDS line data corresponding to the TMDS channel 1.

Thus, the MHL reception unit determines to which of the TMDS channels each of pieces of TMDS line data input to the inputs (1) to (X) corresponds, on the basis of the ID, and optionally rearranges the pieces of TMDS line data. Therefore, even when TMDS line data (1) to (X) are not correctly input to the inputs (1) to (X) of the MHL reception unit, MHL data can be appropriately reconstructed.

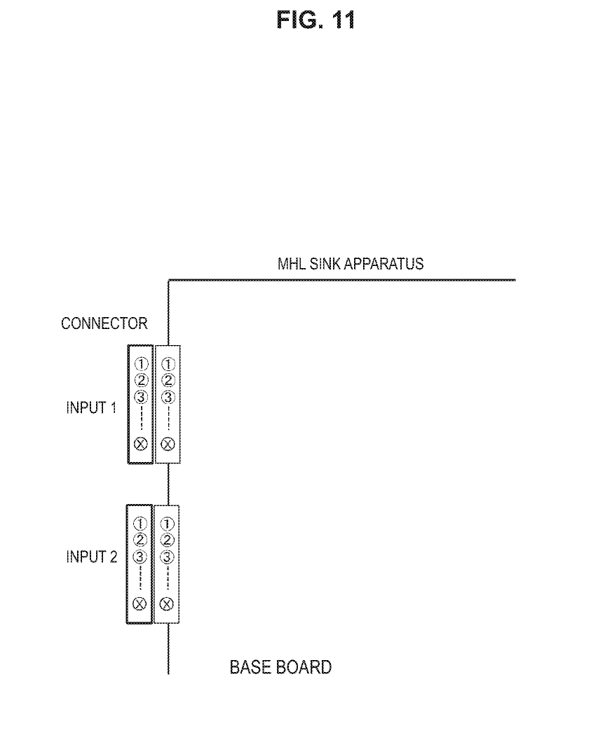

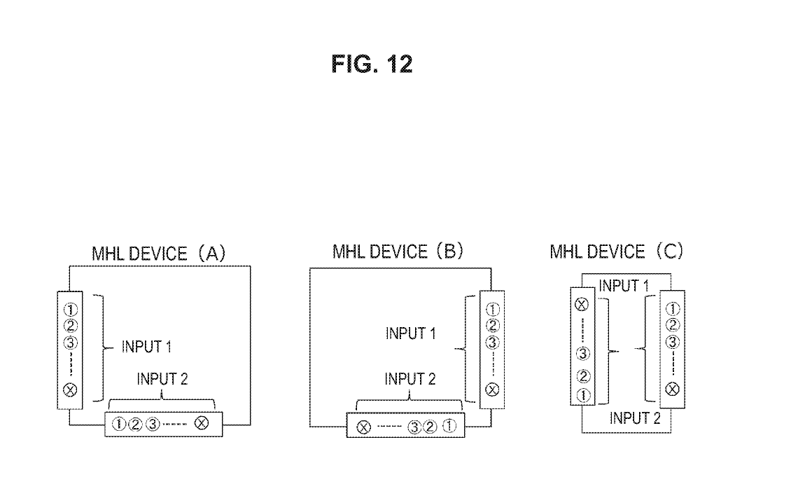

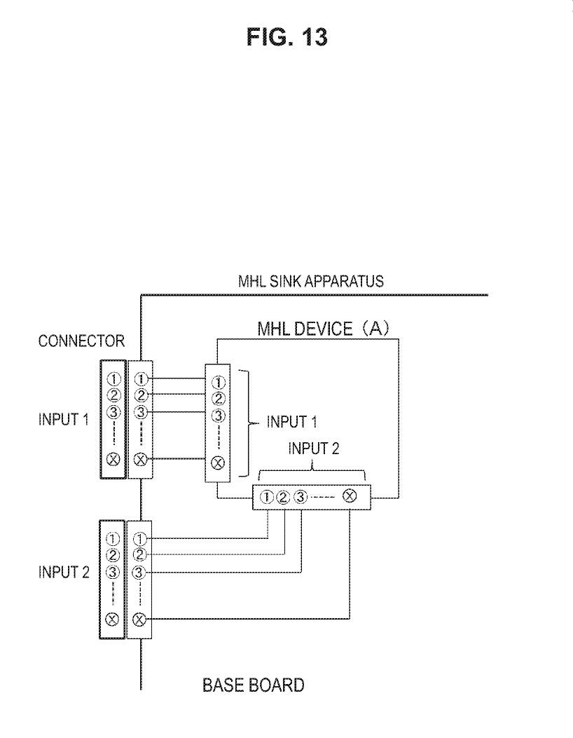

Also, in the image display system 10 of FIG. 1, the efficiency of base board design can be improved. In this case, for example, a situation will be described in which there is an MHL sink apparatus having a base board which has a shape and a connector arrangement as shown in FIG. 11, and, for example, MHL devices (MHL reception units) (A), (B), and (C) shown in FIG. 12 are arranged in the MHL sink apparatus. When the MHL device (A) is arranged, a shortest pattern can be provided from the connectors to the device as shown in FIG. 13, resulting in good characteristics.

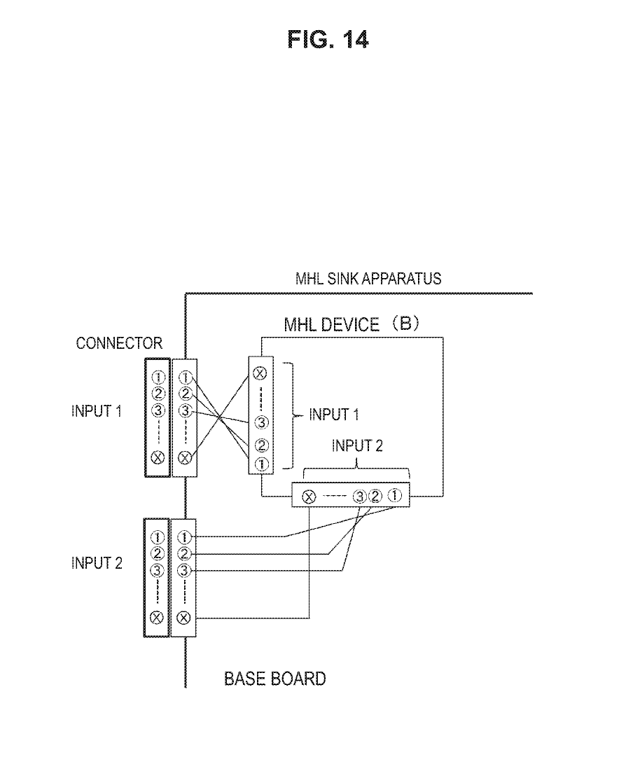

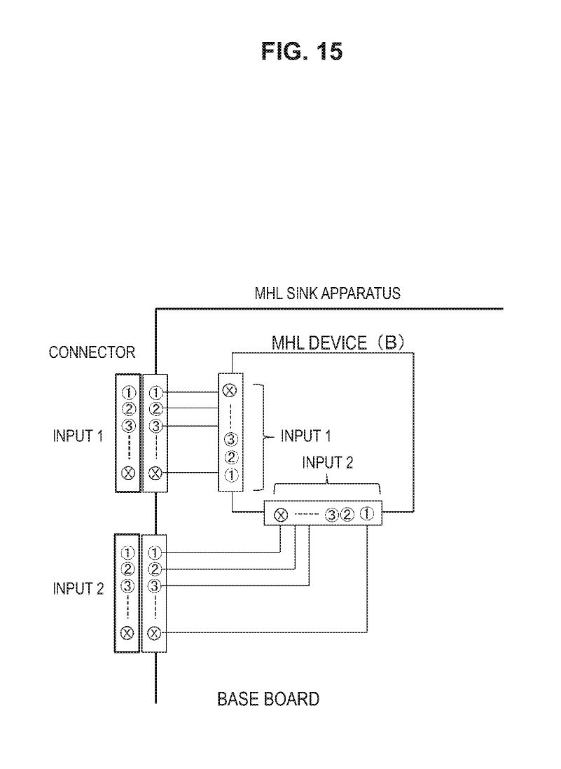

Also, when the MHL device (B) is arranged, a wiring pattern is typically complicated as shown in FIG. 14, and therefore, in order to obtain good characteristics, it is necessary to use a multilayer base board or a base board having good characteristics. However, if the present technology is employed, it does not matter to which input of the MHL device each piece of TMDS line data is input, and therefore, a shortest pattern can be designed as shown in FIG. 15.

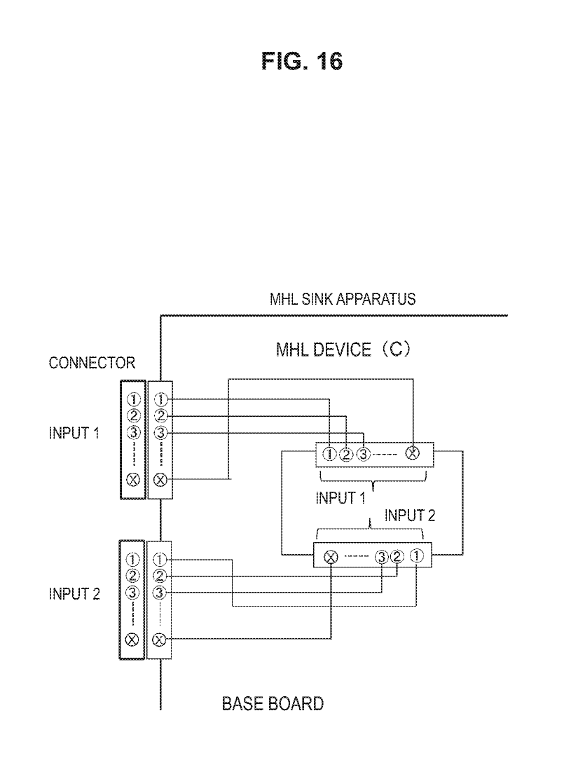

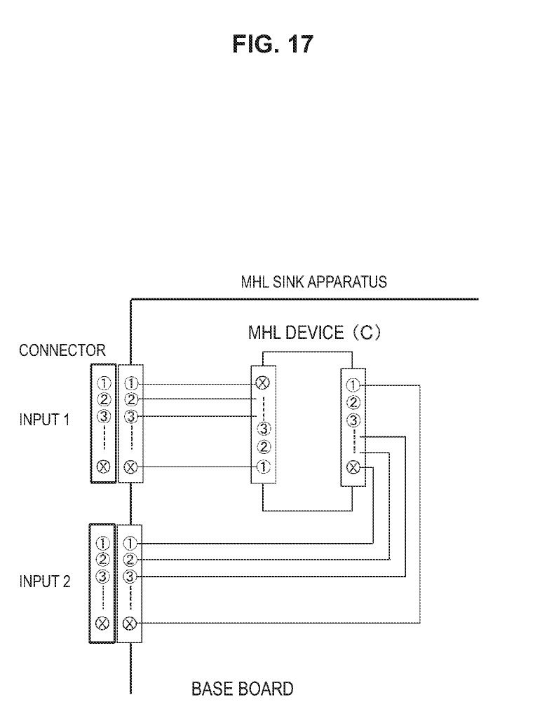

Also, when the MHL device (C) is arranged, a wiring pattern typically has a cross point as shown in FIG. 16, and therefore, in order to obtain good characteristics, it is necessary to use a multilayer base board or a base board having good characteristics. However, if the present technology is employed, it does not matter to which input of the MHL device each piece of TMDS line data is input, and therefore, a shortest pattern can be designed as shown in FIG. 17.

### <2. Variations>

Note that, in the above embodiments, an example has been described in which a single piece of content data is transmitted and received through the TMDS data channels 0 to X. Alternatively, the TMDS data channels 0 to X may be divided into a plurality of groups, and a plurality of pieces of content data may be transmitted and received in parallel.

Also, in the above embodiments, an example has been described in which an MHL source apparatus and an MHL sink apparatus are connected together through an MHL digital interface. Alternatively, the present technology can also be similarly applied to a case where a transmission apparatus and a reception apparatus are connected together through other digital interfaces, such as High-Definition Multimedia Interface (HDMI) and the like. Note that “HDMI” and “MHL” are a registered trademark.

Additionally, the present technology may also be configured as below.

(1)

A transmission apparatus including:

a transmission unit configured to transmit a plurality of streams of data corresponding to respective ones of a plurality of data channels, to an external apparatus through a transmission path; and

an information addition unit configured to add, to each of the plurality of streams of data, identification information for identifying the corresponding data channel.

(2)

The transmission apparatus according to (1),

wherein the data channel is a TMDS data channel, and

the information addition unit inserts, into a control period of each piece of TMDS line data, the identification information for identifying the corresponding data channel.

(3)

The transmission apparatus according to (1) or (2),

wherein information about the total number of the data channels is added to the identification information for identifying the corresponding data channel.

(4)

The transmission apparatus according to any of (1) to (3), further including:

a data processing unit configured to obtain the plurality of streams of data from one or more pieces of content data.

(5)

The transmission apparatus according to any of (1) to (4), further including:

a receptacle having a plurality of pins for outputting respective ones of the plurality of streams of data,

wherein the receptacle is reversibly connectable to a plug of a cable forming the transmission path.

(6)

A transmission method including:

a transmission step of transmitting, by a transmission unit, a plurality of streams of data corresponding to respective ones of a plurality of data channels, to an external apparatus through a transmission path; and

an information addition step of adding, to each of the plurality of streams of data, identification information for identifying the corresponding data channel.

(7)

A reception apparatus including:

a reception unit configured to receive a plurality of streams of data, to each of which identification information for identifying a corresponding data channel is added, from an external apparatus through a transmission path; and

a determination unit configured to determine to which of the data channels each of the plurality of streams of data corresponds, on the basis of the inserted identification information.

(8)

The reception apparatus according to (7),

wherein the data channel is a TMDS data channel, and

the identification information is inserted in a control period of TMDS line data.

(9)

The reception apparatus according to (7) or (8), further including:

a data processing unit configured to combine the plurality of streams of data together, on the basis of a result of the determination, to obtain one or more pieces of content data.

(10)

The reception apparatus according to any of (7) to (9), further including:

a receptacle having a plurality of pins for receiving respective ones of the plurality of streams of data,

wherein the receptacle is reversibly connectable to a plug of a cable forming the transmission path.

(11)

A reception method including:

a reception step of receiving, by a reception unit, a plurality of streams of data, to each of which identification information for identifying a corresponding data channel is added, from an external apparatus through a transmission path; and

a determination step of determining to which of the data channels each of the plurality of streams of data corresponds, on the basis of the inserted identification information.

### REFERENCE SIGNS LIST

10 image display system

100 mobile phone

101 CPU

102 user operation unit

103 display control unit

104 display unit

105 3G/4G modem

106 camera unit

107 recording/reproduction unit

108 transmission process unit

109 MHL transmission unit

110 MHL terminal

111 power supply unit

121 MHL data generation unit

122 division unit

123-1 to 123-X TMDS encoder

124-1 to 124-X serializer

200 television set

201 CPU

202 user operation unit

203 display control unit

204 MHL terminal

205 MHL reception unit

206 reception process unit

207 tuner

208 antenna terminal

209 switching unit

210 display unit

211 power supply unit

221-1 to 221-X deserializer

222-1 to 222-X TMDS decoder

223 combination unit

224 MHL data separation unit

300 MHL cable

1. A transmission apparatus comprising:
a transmission unit configured to transmit a plurality of streams of data corresponding to respective ones of a plurality of data channels, to an external apparatus through a transmission path; and
an information addition unit configured to add, to each of the plurality of streams of data, identification information for identifying the corresponding data channel.

2. The transmission apparatus according to claim 1,
wherein the data channel is a TMDS data channel, and
the information addition unit inserts, into a control period of each piece of TMDS line data, the identification information for identifying the corresponding data channel.

3. The transmission apparatus according to claim 1,
wherein information about the total number of the data channels is added to the identification information for identifying the corresponding data channel.

4. The transmission apparatus according to claim 1, further comprising:
a data processing unit configured to obtain the plurality of streams of data from one or more pieces of content data.

5. The transmission apparatus according to claim 1, further comprising:
a receptacle having a plurality of pins for outputting respective ones of the plurality of streams of data,
wherein the receptacle is reversibly connectable to a plug of a cable forming the transmission path.

6. A transmission method comprising:
a transmission step of transmitting, by a transmission unit, a plurality of streams of data corresponding to respective ones of a plurality of data channels, to an external apparatus through a transmission path; and
an information addition step of adding, to each of the plurality of streams of data, identification information for identifying the corresponding data channel.

7. A reception apparatus comprising:
a reception unit configured to receive a plurality of streams of data, to each of which identification information for identifying a corresponding data channel is added, from an external apparatus through a transmission path; and
a determination unit configured to determine to which of the data channels each of the plurality of streams of data corresponds, on the basis of the inserted identification information.

8. The reception apparatus according to claim 7,
wherein the data channel is a TMDS data channel, and
the identification information is inserted in a control period of TMDS line data.

9. The reception apparatus according to claim 7, further comprising:
a data processing unit configured to combine the plurality of streams of data together, on the basis of a result of the determination, to obtain one or more pieces of content data.

10. The reception apparatus according to claim 7, further comprising:
a receptacle having a plurality of pins for receiving respective ones of the plurality of streams of data,
wherein the receptacle is reversibly connectable to a plug of a cable forming the transmission path.

11. A reception method comprising:
a reception step of receiving, by a reception unit, a plurality of streams of data, to each of which identification information for identifying a corresponding data channel is added, from an external apparatus through a transmission path; and
a determination step of determining to which of the data channels each of the plurality of streams of data corresponds, on the basis of the inserted identification information.
